(19) United States
(12) Patent Application Publication
(10) Pub. No.: US 2026/0310670 A1
(43) Pub. Date: Oct. 8, 2026

(54) ADAPTIVE VECTOR QUERY PROCESSING

(71) Applicant: Google LLC, Mountain View, CA (US)

(72) Inventors: Vaibhav Jain, Bengaluru (IN); Yannis Papakonstantinou, La Jolla, CA (US); Vinay Sharma, Bengaluru (IN); Wing Hang Li, Santa Clara, CA (US); Sam Idicula, Santa Clara, CA (US)

(21) Appl. No.: 19/571,592

(22) Filed: Mar. 19, 2026

(30) Foreign Application Priority Data
Apr. 8, 2025 (IN) 202541034259

(51) Int. Cl. G06F 16/2453; G06F 16/22

(52) U.S. Cl. CPC G06F 16/24549; G06F 16/2237; G06F 16/24542

(57) ABSTRACT

A method includes storing a set of data records including vectors and structured attribute fields. The method further includes receiving a query including a query vector and one or more filter conditions. The method also includes executing a first portion of the query on a relational database by at least applying a first evaluation strategy. The first evaluation strategy is from a set of evaluation strategies. The method additionally includes generating, during execution of the first portion of the query, runtime statistics of the first portion of the query. The method further includes determining, based on the runtime statistics, whether to execute a second portion of the query via a second evaluation strategy of the set of evaluation strategies. The method also includes, responsive to the determination, executing the second portion of the query by at least applying the second evaluation strategy.

This application claims the benefit of IN Provisional Patent Application No. 202541034259, filed 8 Apr. 2025, the entire contents of which is incorporated herein by reference.

### BACKGROUND

As applications today generate significant amounts of data, systems, such as online analytical processing (OLAP) and online transactional processing (OLTP) systems, continue to evolve to support data analysis. Moreover, if a user is unable to perform analysis over his or her data in a manner that is efficient and/or cost-effective, the value of generating a vast amount of data may significantly diminish. To ensure that a user is able to make the best use of data, a user will want to ensure that the processing system is operating quickly and efficiently. For example, in a query processing system, a user can use query statistics related to the execution of a query to better understand the utilization of the database resources and the performance of the query processing system. In both OLAP and OLTP systems, a query may include insert, delete, update, and/or select functions, where the execution of any of these functions generates query statistics.

### SUMMARY

In general, techniques of this disclosure are directed to adapting a query evaluation strategy during query execution. A relational database management system, such as a PostgreSQL-based system, may receive a query for execution on a data store. The data store may include an amount of data records, where each data record includes one or more vectors and one or more structured attribute fields. The query may include one or more query vectors for searching the one or more vectors. Additionally, the query may include one or more filter conditions for searching the structured attribute fields. The relational database management system may execute the query using a first evaluation strategy (e.g., a pre-filtering, post-filtering, or inline evaluation strategy). During query execution, the relational database management system may transition to using a different evaluation strategy based on runtime statistics associated with the query execution. In this way, the relational database management system may, during query execution, dynamically transition to an evaluation strategy that is better-suited for a provided query.

In one example, the disclosure is directed toward a method that includes storing, by a computing system and in a relational database, a set of data records including vectors and structured attribute fields, each data record including a respective vector and one or more respective structured attribute fields. The method further includes receiving, by the computing system, a query including a query vector and one or more filter conditions. The method also includes executing, by the computing system, a first portion of the query on the relational database by at least applying a first evaluation strategy. The first evaluation strategy is for searching the vectors based on the query vector and for searching the structured attribute fields based on the one or more filter conditions, and the first evaluation strategy is from a set of evaluation strategies. The method additionally includes generating, by the computing system and during execution of the first portion of the query, runtime statistics of the first portion of the query. The method further includes determining, by the computing system and based on the runtime statistics, whether to execute a second portion of the query by at least applying a second evaluation strategy of the set of evaluation strategies. The second evaluation strategy is for searching the vectors based on the query vector and for searching the structured attribute fields based on the one or more filter conditions, and the second evaluation strategy is different than the first evaluation strategy. The method also includes, responsive to determining to execute the second portion of the query by at least applying the second evaluation strategy, executing, by the computing system, the second portion of the query by at least applying the second evaluation strategy.

In another example, the disclosure is directed toward a computing device comprising one or more processors, and one or more storage devices that store instructions. The instructions, when executed by the one or more processors, cause the one or more processors to store, in a relational database, a set of data records including vectors and structured attribute fields, each data record including a respective vector and one or more respective structured attribute fields. The instructions further cause the one or more processors to receive a query including a query vector and one or more filter conditions. The instructions also cause the one or more processors to execute a first portion of the query on the relational database by at least applying a first evaluation strategy. The first evaluation strategy is for searching the vectors based on the query vector and for searching the structured attribute fields based on the one or more filter conditions, and the first evaluation strategy is from a set of evaluation strategies. The instructions additionally cause the one or more processors to generate, during execution of the first portion of the query, runtime statistics of the first portion of the query. The instructions further cause the one or more processors to determine, based on the runtime statistics, whether to execute a second portion of the query by at least applying a second evaluation strategy of the set of evaluation strategies. The second evaluation strategy is for searching the vectors based on the query vector and for searching the structured attribute fields based on the one or more filter conditions, and the second evaluation strategy is different than the first evaluation strategy. The instructions also cause the one or more processors to, responsive to determining to execute the second portion of the query by at least applying the second evaluation strategy, execute the second portion of the query by at least applying the second evaluation strategy.

In another example, the disclosure is directed toward a non-transitory computer-readable storage medium encoded with instructions that, when executed by one or more processors of a computing device, cause the one or more processors to store, in a relational database, a set of data records including vectors and structured attribute fields, each data record including a respective vector and one or more respective structured attribute fields. The instructions further cause the one or more processors to receive a query including a query vector and one or more filter conditions. The instructions also cause the one or more processors to execute a first portion of the query on the relational database by at least applying a first evaluation strategy. The first evaluation strategy is for searching the vectors based on the query vector and for searching the structured attribute fields based on the one or more filter conditions, and the first evaluation strategy is from a set of evaluation strategies. The instructions additionally cause the one or more processors to generate, during execution of the first portion of the query, runtime statistics of the first portion of the query. The instructions further cause the one or more processors to determine, based on the runtime statistics, whether to execute a second portion of the query by at least applying a second evaluation strategy of the set of evaluation strategies. The second evaluation strategy is for searching the vectors based on the query vector and for searching the structured attribute fields based on the one or more filter conditions, and the second evaluation strategy is different than the first evaluation strategy. The instructions also cause the one or more processors to, responsive to determining to execute the second portion of the query by at least applying the second evaluation strategy, execute the second portion of the query by at least applying the second evaluation strategy.

In another example, the disclosure is directed toward a computer program product for performing queries on a database. The computer program product comprises one or more instructions that, when executed by at least one processor of a computing device, cause the at least one processor to store, in a relational database, a set of data records including vectors and structured attribute fields, each data record including a respective vector and one or more respective structured attribute fields. The one or more instructions further cause the at least one processor to receive a query including a query vector and one or more filter conditions. The one or more instructions also cause the at least one processor to execute a first portion of the query on the relational database by at least applying a first evaluation strategy. The first evaluation strategy is for searching the vectors based on the query vector and for searching the structured attribute fields based on the one or more filter conditions, and the first evaluation strategy is from a set of evaluation strategies. The one or more instructions additionally cause the at least one processor to generate, during execution of the first portion of the query, runtime statistics of the first portion of the query. The one or more instructions further cause the at least one processor to determine, based on the runtime statistics, whether to execute a second portion of the query by at least applying a second evaluation strategy of the set of evaluation strategies. The second evaluation strategy is for searching the vectors based on the query vector and for searching the structured attribute fields based on the one or more filter conditions, and the second evaluation strategy is different than the first evaluation strategy. The one or more instructions further cause the at least one processor to, responsive to determining to execute the second portion of the query by at least applying the second evaluation strategy, execute the second portion of the query by at least applying the second evaluation strategy.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram of an example system for executing queries on a relational database, in accordance with one or more techniques of this disclosure.

FIG. 2 is a flowchart illustrating an example technique for adapting a query evaluation strategy during query execution, in accordance with one or more techniques of this disclosure.

### DETAILED DESCRIPTION

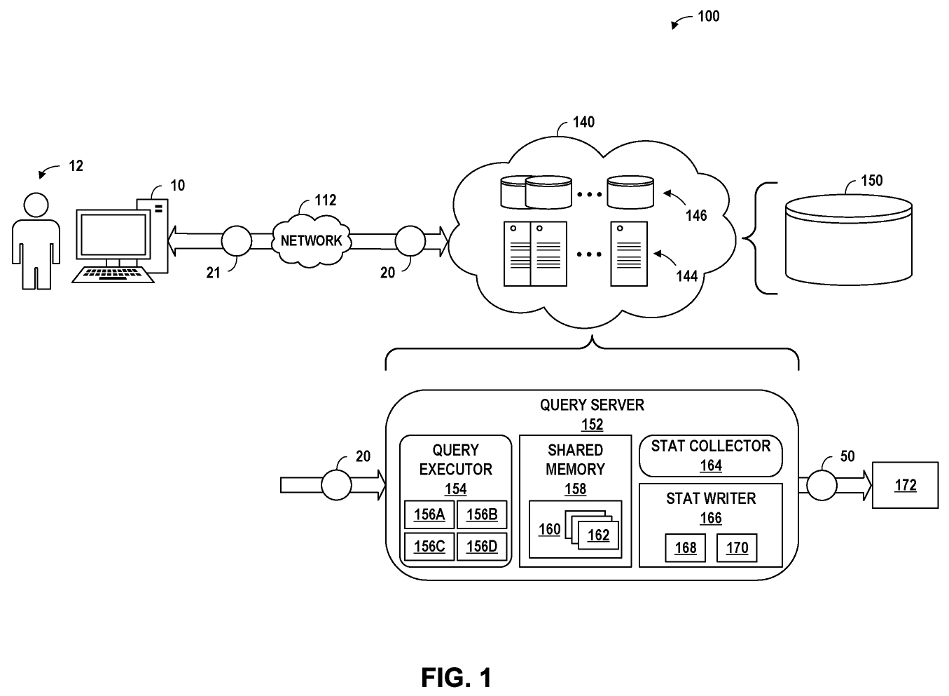

FIG. 1 is a conceptual diagram of an example system for executing queries on a relational database, in accordance with one or more techniques of this disclosure. As shown in FIG. 1, system 100 includes cloud environment 140 (e.g., a computing system such as a high-performance remote server or cluster of high-performance remote servers) in communication with user device 10 via network 112. User device 10 may be configured to submit query 20 (e.g., via a Structured Query Language (SQL) interface or the like) to cloud environment 140. User device 10 may be any computing device configured to submit queries to a cloud environment, such as a desktop workstation, a laptop workstation, or a mobile device (e.g., a smartphone). User device 10 may include computing resources (e.g., data processing hardware) and/or storage resources (e.g., memory hardware).

Cloud environment 140 may be a single computer, multiple computers, or a distributed system having resources including computing resources 144 (e.g., data processing hardware) and/or storage resources 146 (e.g., memory hardware). Cloud environment 140 may include query server 152 for executing query 20. Storage resources 146 may include data store 150 to enable scalable use of storage resources 146 by one or more of the clients (e.g., user device 10) or computing resources 144. Data store 150 may be configured to store data (e.g., data records) for query 20. In other words, query 20 may be related to data stored at data store 150. Data store 150 may also be configured to store data for the query statistics of query 20. In other words, data store 150 may store both query data for query 20 as well as query statistics 50 of query 20. The data of data store 150 may include a set of data records. Each data record may include one or more vectors (e.g., numerical representations of data such as text, images, and audio) and one or more structured attribute fields (e.g., fields including data types such as strings, integers, dates, and categories). Query 20 may include one or more query vectors for searching the one or more vectors. Additionally, or alternatively, query 20 may include one or more filter conditions for searching the one or more structured attribute fields.

Cloud environment 140 executes query server 152 (including query executor 154, shared memory 158, statistics collector 164, and statistics writer 166) for executing query 20 against data store 150. In some implementations, query server 152 is a process-based query system (e.g., a PostgreSQL-based system). FIG. 1 shows evaluation strategy module 156A, evaluation strategy module 156B, evaluation strategy module 156C, and evaluation strategy module 156D (collectively referred to as “evaluation strategy modules 156”). Query server 152 may execute query 20 via an evaluation strategy module of evaluation strategy modules 156. Additionally, query executor 154 may store data related to query 20 in shared memory 158 of query server 152 before, during, and/or after execution of query 20. In some implementations, query executor 154 is configured to store query statistics 50 as one or more records of linked list 160.

Query executor 154 may execute query 20 using a first evaluation strategy of evaluation strategy modules 156. During execution of query 20, query executor 154 may transition to executing query 20 by instead using a second evaluation strategy of evaluation strategy modules 156. Query executor 154 may transition from using a first evaluation strategy to using a second evaluation strategy based on query statistics 50. In the example illustrated with respect to FIG. 1, evaluation strategy modules 156 include evaluation strategy module 156A, evaluation strategy module 156B, evaluation strategy module 156C, and evaluation strategy module 156D.

Evaluation strategy module 156A may specify a pre-filtering evaluation strategy. Query executor 154 may implement evaluation strategy module 156A to execute query 20 on data records of data store 150 via the pre-filtering evaluation strategy. For instance, query executor 154 may first apply filter conditions on data records of data store 150 using indexes or a sequential scan. Query executor 154 may then execute a vector search on the filtered data records via a vector query. In some examples, the pre-filtering evaluation strategy may implement a k-nearest neighbor (KNN) search. Query executor 154 may first fetch the matching rows of the data records via, e.g., an index or sequential scan. Query executor 154 may then sort the matching results based on an ORDER BY clause (e.g., ORDER BY vector_col <=>‘[1, 2, 3]’). In some implementations, query executor 154 may execute a first portion of query 20 via the pre-filtering evaluation strategy of evaluation strategy module 156A. During query execution, query executor 154 may transition by executing a second portion of query 20 via a different evaluation strategy of evaluation strategy modules 156.

Evaluation strategy module 156B may specify a post-filtering evaluation strategy. Query executor 154 may implement evaluation strategy module 156B to execute query 20 on data records of data store 150 via the post-filtering evaluation strategy. For instance, query executor 154 may first use a query vector of query 20 to execute a vector search on the data records of data store 150. Then, query executor 154 may apply filter conditions to the resulting data records. In some implementations, query executor 154 utilizes a post-filtering strategy in approximate nearest neighbors (ANN) index scans, where query executor 154 first identifies the closest vectors from the query vector and then applies the filter conditions on the top vectors. Query executor 154 may store a subset of the top vectors in a queue (e.g., post inflation to prevent under-reports). Additionally, query executor 154 may store the vectors in selected leaves in a sorted fashion in an array (e.g., when inflation cannot be reliably determined).

Evaluation strategy module 156C may specify an inline-filtering evaluation strategy. Query executor 154 may implement evaluation strategy module 156C to execute query 20 on data records of data store 150 via the inline-filtering evaluation strategy. For example, query executor 154 may traverse a vector index, such as a Scalable Nearest Neighbors (ScaNN) index, to identify candidate vectors based on similarity to a query vector. Query executor 154 may apply one or more filter conditions during the traversal process, either immediately before or after computing vector distances. In some implementations, query executor 154 may use a pre-generated bitmap derived from structured attribute fields to restrict the index traversal to records that satisfy the filter conditions.

Using inline-filtering, query executor 154 may apply filter predicate(s) on vector(s) whilst scanning the “scaNN” index itself. Query executor 154 may apply the filter predicate to the vector when reading the vector from the “scaNN” index page before or after the query executor 154 performs distance computation on the vector. Query executor 154 may implement inline-filtering via bitmaps. For instance, query executor 154 may generate a bitmap for the filter condition using an appropriate index (B-tree, GIN, etc). Then, query executor 154 may use the bitmap to determine whether a particular vector in the “scaNN” index qualifies the filter predicate.

Evaluation strategy module 156D may specify a hybrid filtering evaluation strategy (also referred to as a hybrid inline-post filtering strategy). Query executor 154 may implement evaluation strategy module 156D to execute query 20 on data records of data store 150 via the hybrid filtering evaluation strategy. For example, query executor 154 may evaluate a subset of filter clauses using inline-filtering during traversal of a ScaNN index, while deferring evaluation of the remaining filter clauses to a post-filtering stage after retrieving candidate vectors. This selective application of filter predicates may be based on factors such as filter selectivity and the availability of supporting indexes. In some examples, query executor 154 may apply filter clauses with high selectivity (e.g., those that significantly reduce the result set) via inline-filtering to reduce distance computations. Query executor 154 may defer filter clauses with low selectivity to post-filtering to avoid over-constraining the index scan and to improve query performance.

The evaluation strategies of evaluation strategy modules 156 are provided as examples. In some implementations, query executor 154 may be configured to use more or fewer evaluation strategies than those described with respect to evaluation strategy modules 156. Additionally, evaluation strategy modules 156 may include any strategy for performing queries on data records other than those described with respect to evaluation strategy modules 156.

While query executor 154 executes query 20 on data records of data store 150 via a strategy of evaluation strategy modules 156, statistics collector 164 may obtain query statistics 50 related to query 20 from shared memory 158 of query server 152. Query statistics 50 may include any statistics related to the execution of query 20 such as wait event statistics, plan statistics, query processing statistics, buffer usage statistics, usage statistics, etc. In some implementations, statistics collector 164 stores query statistics 50 in records 162 of linked list 160. Statistics collector 164 may periodically obtain query statistics 50, and each time (e.g., at each time step statistics collector 164 obtains query statistics 50) generate another record for query statistics 50. In some implementations, each record of linked list 160 may include a query identifier indicating a corresponding query. For example, query server 152 may execute multiple queries simultaneously. Statistics collector 164 may obtain query statistics 50 related to each of the simultaneously executing queries and generate a respective record (e.g., of records 162) for statistics of the corresponding query. The respective record may include an identifier of the corresponding query (e.g., data that uniquely identifies the corresponding query).

Statistics writer 166 may transmit/write query statistics 50 to statistics storage 172. In some implementations, statistics writer 166 first determines whether query execution duration 168 of query 20 (e.g., an amount of time that elapsed during execution of query 20) satisfies threshold 170. If the query execution duration 168 of query 20 satisfies threshold 170, statistics writer 166 may persist the corresponding query statistics of each record in linked list 160 that corresponds to query 20 by, e.g., recording the query statistics in statistics storage 172. However, when the query execution duration 168 of query 20 fails to satisfy threshold 170, statistics writer 166 may discard the corresponding query statistics of each record in linked list 160 that corresponds to query 20.

When writing query statistics 50 to statistics storage 172, statistics writer 166 may write each statistic of query statistics 50 to a single data table or multiple data tables of statistics storage 172. In some implementations, statistics storage 172 is persistent and/or non-volatile such that data, by default, is not overwritten or erased by new incoming data. Furthermore, in some implementations, shared memory 158 and statistics storage 172 may be co-located in a same system (e.g., cloud environment 140).

In some examples, data store 150 is a data warehouse (e.g., a plurality of databases) as a means of data storage for user 12 (or multiple users). Data store 150 may store data from one or more sources and may be configured to analyze, report, and/or integrate data from the sources. Data store 150 may enable users (e.g., organizational users) to have a central storage depository and storage data access point. Data store 150 may simplify data retrieval for functions such as data analysis and/or data reporting (e.g., by query server 152 for executing queries). Furthermore, data store 150 may be configured to store data such that user 12 (e.g., an organizational user) can store large amounts of historical data to understand data trends. Being that data store 150 may be a main or primary data storage depository of data, data store 150 may receive large amounts of data (e.g., gigabytes per second, terabytes per second, or more) from user devices associated with one or more users.

Query server 152 may be configured to request information or data from data store 150 when executing query 20. In some examples, query 20 is initiated by user 12 (via user device 10) as a request for data within data store 150 (e.g., an export data request). For instance, user 12 may interact with query server 152 (e.g., an interface, such as an SQL interface, associated with query server 152) to retrieve data stored in data store 150 of cloud environment 140. Here, query 20 may be user-originated (e.g., directly requested by user 12) or system-originated (e.g., generated by query server 152). In some examples, query server 152 configures routine or repeating queries (e.g., at some designated frequency) to enable user 12 to perform analytics or to monitor data stored in data store 150.

The format of query 20 may include a reference to data stored in data store 150. In some implementations, query 20 includes one or more query vectors for searching vectors stored at data store 150. Additionally, or alternatively, query 20 includes one or more filter conditions for searching structured attribute fields stored at data store 150. In response to receiving query 20, query server 152 may generate query response 21 to fulfill the request of query 20 (e.g., a request for particular data). Query response 21 may include data that query server 152 obtains in response to searching data store 150 based on query 20. Query server 152 may return query response 21 to an entity that originates query 20 (e.g., user 12) or another entity or system communicating with system 100. Further, as discussed, query server 152 may also be configured to collect query statistics 50 related to query 20.

According to various aspects of the present disclosure, query server 152 may adapt a query plan based on query statistics 50. That is, query server 152 may continuously monitor runtime statistics during query processing to dynamically adjust evaluation strategies. For instance, query server 152 may execute query 20 using one of the described filtration strategies, e.g., pre-filtering, post-filtering, or inline-filtering. Query server 152 may then switch the chosen filtration strategy to a different filtration strategy based on the execution characteristics reflected by query statistics 50. Specifically, query server 152 may switch from one execution strategy to a different execution strategy by observing runtime statistics during query execution (and not during query planning). For example, query server 152 may start with an inline-filtering execution strategy. Based on the observed statistics during inline-filtering, query server 152 may switch to a pre-filter or post-filter strategy.

In some implementations, cloud environment 140 may store, in a relational database (e.g., data store 150), a set of data records including vectors and structured attribute fields. Each data record may include a respective vector and one or more respective structured attribute fields. Cloud environment 140 may then receive query 20, where query 20 includes a query vector and one or more filter conditions. For example, the query vector may be an embedding generated from an input text, image, or audio provided by user 12, where the embedding represents the semantic meaning of the input. In this example, the one or more filter conditions may be structured constraints such as category = ‘electronics’, price < 100, or region = ‘US’.

After receiving query 20, query executor 154 of query server 152 may execute a first portion of the query on the relational database by at least applying a first evaluation strategy. For instance, query executor 154 may begin executing query 20 by applying an inline-filtering evaluation strategy of evaluation strategy module 156A. During execution of the first portion of query 20, statistics collector 164 may generate runtime statistics (e.g., query statistics 50) of the first portion of query 20. The runtime statistics may include, for example, wait event statistics, plan statistics, query processing statistics, buffer usage statistics, hardware usage statistics, runtime statistics, and/or matching data record statistics associated with executing the first portion of query 20. Statistics writer 166 may then provide the runtime statistics to statistics storage 172.

Query executor 154 may determine, based on the runtime statistics, whether to execute a second portion of query 20 using a different evaluation strategy of evaluation strategy modules 156. For example, prior to executing the first portion of query 20, query executor 154 may determine an estimated amount of matching data records for the first portion of query 20. Query executor 154 may determine the estimated amount of matching data records, by, for example, analyzing metadata associated with relevant columns of data store 150. The metadata may be, for instance, histograms, most common values (MCVs), null fractions, or distinct counts gathered during a prior ANALYZE operation. In some implementations, query executor 154 may also use multi-column correlation statistics or sampling techniques to estimate the selectivity of filter predicates and determine the estimated amount of matching data records.

After executing the first portion of query 20, query executor 154 may determine an actual amount of matching data records associated with executing the first portion. Query executor 154 may then determine to instead use a second evaluation strategy based on determining whether a difference between the estimated amount of matching data records and the actual amount of matching data records satisfies an evaluation strategy switching threshold. For instance, query executor 154 may execute a first portion of query 20 via an inline-filtering evaluation strategy of evaluation strategy module 156C. Query executor 154 may estimate that the first portion of query 20 may return, for example, 1,000 matching data records. Query executor 154 may then execute the first portion of query 20 and return 5,000 matching data records. In this example, query executor 154 may transition, during execution of query 20, to instead using a different evaluation strategy based on the difference between the estimated matching data records and the actual data records exceeding 3,000. In some implementations, the evaluation strategy switching threshold may instead implement any other means of comparing the estimated amount of matching data records to the actual amount of matching data records. For instance, the evaluation strategy switching threshold may be a percentage of actual matching data records as compared to estimated matching data records.

In some implementations, query executor 154 may switch from an inline-filtering evaluation strategy to a pre-filtering evaluation strategy based on determining that query executor 154 overestimated the amount of matching data records. For instance, query executor 154 may estimate that a first portion of query 20 will return 100,000 matching data records (e.g., rows of a table stored at data store 150). If the first portion of query 20 instead returns 100 matching data records, query executor 154 may instead execute a second portion of query 20 using a pre-filtering evaluation strategy.

In still some implementations, query executor 154 may switch from an inline-filtering evaluation strategy to a post-filtering evaluation strategy based on determining that query executor 154 underestimated the amount of matching data records. For instance, query executor 154 may estimate that a first portion of query 20 will return 100 matching data records (e.g., rows of a table stored at data store 150). If the first portion of query 20 instead returns 100,000 matching data records, query executor 154 may instead execute a second portion of query 20 using a post-filtering evaluation strategy. For instance, query executor 154 may stop generating a bitmap based on an inline-filtering evaluation strategy and instead switch to a post-filtering evaluation strategy.

Query executor 154 may determine to transition to a different evaluation strategy in response to determining that a query vector of query 20 and one or more filter conditions of query 20 are negatively correlated. The query vector and the filter conditions may be negatively correlated if, for example, vectors farthest from the query vector will pass the filter condition. For example, a query vector representing a semantic embedding of the word “sports” may return results that are most similar to sports-related content. A filter condition such as category = ‘formalwear’ may only match items that are semantically dissimilar to “sports.” In this example, the most relevant results in terms of vector similarity are unlikely to satisfy the filter, and the items that do satisfy the filter are likely to be far from the query vector in embedding space. Because the filter and query vector are negatively correlated, rather than traversing an entire vector index, query executor 154 may instead transition to using a different evaluation strategy (e.g., a pre-filtering evaluation strategy).

In response to determining to execute the second portion of query 20 via a different evaluation strategy, query executor 154 may execute the second portion of the query via the different evaluation strategy. As discussed, aspects of the present disclosure include executing a first portion of a query via a first strategy and then using a second strategy to execute a second portion of the query. However, the same or similar techniques may apply to executing one or more queries via a first strategy and then using a second strategy to execute one or more additional queries. For instance, query executor 154 may receive two queries to execute on data store 150. Query executor 154 may execute the first query using a first evaluation strategy. Based on statistics associated with executing the first query, query executor 154 may transition to executing the second query using a different evaluation strategy.

As discussed, evaluation strategy module 156C may specify an inline-filtering evaluation strategy. Inline-filtering may be bitmap-assisted. For instance, query executor 154 may perform inline-filtering via bitmaps. Query executor 154 may generate a bitmap for the filter clause of query 20 using an index (e.g., B-tree, GIN, etc.). Then, query executor 154 may use the bitmap to determine whether a particular vector in the scaNN index qualifies the filter predicate. The scan index, or Scalable Nearest Neighbors index, may be a vector index structure used to perform ANN searches in vector spaces.

Query executor 154 may first perform bitmap-based inline filtering and, during runtime, switch to either pre-filtering or post-filtering. If the bitmap size is smaller than estimated, query executor 154 may switch to pre-filtering. If the bitmap size is higher than estimated, query executor 154 may switch to post-filtering. In some implementations, query executor 154 may halt bitmap generation midway to switch to a different strategy. Query executor 154 may start with a post-filtering strategy and, based on early sampling, switch to inline or pre-filtering. Additionally, query executor 154 may start by pre-filtering and switch to inline-filtering or post-filtering.

While executing a first evaluation strategy, if query executor 154 determines that a second evaluation strategy would be more optimal, switching to the second evaluation strategy during runtime may not be more optimal. For instance, query executor 154 may generate all or part of a bitmap as part of executing a first evaluation strategy. If, at this point, query executor 154 determines that heap-based post-filtering would be better, query executor 154 may refrain from switching to heap-based post-filtering. At this point, query executor 154 has already paid most of the cost of bitmap generation.

To perform pre-filtration, query executor 154 may generate a bitmap or flat hash. Then, query executor 154 may iterate over the bitmap or flat hash and perform heap lookups to find relevant rows. To perform inline-filtration, query executor 154 may generate a bitmap for a subset of filter clauses (e.g., filter conditions) of query 20. Query executor 154 may defer the rest of the filter clauses to post-filtration. Query executor 154 may perform a decision-making process to decide whether to switch to pre-filtering at two execution stages. The first execution stage occurs when query executor 154 completes bitmap generation. The second execution stage occurs when query executor 154 processes a threshold amount of vectors.

At the first execution stage, query executor 154 has generated a bitmap for performing query 20. Query executor 154 may determine whether the bitmap should be used for pre-filtration or inline-filtration based on the size of the bitmap and/or amount of tuples stored in the bitmap. A smaller bitmap may indicate that pre-filtration would be a better strategy than inline-filtration. The determination of whether a pre-filtration or inline-filtration strategy may be better may also be based on other characteristics of the bitmap such as lossiness or whether the underlying data structure is a flat hash.

At the second execution stage, the bitmap may not be small enough to switch to pre-filtration. However, if the bitmap is negatively correlated with the chosen set of leaves, query executor 154 may switch to using pre-filtration. Query executor 154 may infer the negative correlation by starting with inline-filtration and tracking an amount of qualifications and/or disqualifications by the bitmap on a first k vectors. If the disqualifications exceed a threshold, query executor 154 may switch to a pre-filtration strategy. After the switch to pre-filtration, query executor 154 may start from scratch and discard any qualified vectors.

In some implementations, query executor 154 may implement a flat hash instead of a bitmap. For instance, query executor 154 may populate matching tuple identifiers into a flat hash while performing an inline-filtration strategy. Similarly, query executor 154 may transition between evaluation strategies during runtime based on the flat hash. For instance, query executor 154 may perform pre-filtering via the flat hash.

In some implementations, query executor 154 may execute query 20 via declarative recall and/or streaming ANN search techniques. For instance, query executor 154 may traverse leaves of the vector search in an iterative fashion. Query executor 154 may determine to transition evaluation strategies before the start of a streaming scan, e.g., in the first iteration of traversing the leaves of the vector search.

Query executor 154 may utilize a result queue to temporarily buffer a set of intermediate results generated by the first evaluation strategy before returning the set of intermediate results to a requesting entity. In response to determining to execute the second portion of the query via the second evaluation strategy, query executor 154 may discard the set of intermediate results stored in the result queue. Query executor 154 may maintain the result queue to prevent a premature transmission of the set of intermediate results while query executor 154 determines whether to transition to the second evaluation strategy.

Query executor 154 may execute the first portion of the query utilizing a multi-threaded processing approach, such as a multi-threaded ANN search. In response to transitioning to the second evaluation strategy, query executor 154 may execute the second portion of the query utilizing a serial processing approach, such as a serial KNN search. Query executor 154 may alter a threading model associated with the query during a runtime execution of the query.

Query executor 154 may populate a set of matching tuple identifiers into a flat hash set structure during an application of the first evaluation strategy. Query executor 154 may utilize the flat hash set structure to reduce a memory usage associated with the query or to reduce a number of processor cache misses associated with the query. By reducing the memory footprint and the associated processor cache misses, the utilization of the flat hash set structure by query executor 154 may yield substantial performance improvements. For example, in certain selectivity scenarios, the flat hash implementation may significantly reduce a query latency associated with query 20 (e.g., by a factor of two or more) as compared to utilizing a traditional bitmap structure for inline filtration. Query executor 154 may perform a pre-filtration operation utilizing the flat hash set structure in response to determining to transition to the pre-filtration evaluation strategy.

Query executor 154 may update a query plan to indicate the evaluation strategy utilized during the execution of the query. In response to transitioning from the first evaluation strategy to the second evaluation strategy, query executor 154 may modify an execution strategy field of the query plan. For example, query executor 154 may initially set the execution strategy field to indicate the first evaluation strategy. Query executor 154 may subsequently overwrite the execution strategy field to indicate the second evaluation strategy. Query executor 154 may provide the query plan to a user device to enable a user to identify the evaluation strategy that query executor 154 applied to the query. In some implementations, the query plan may include two or more execution strategy fields, where each execution strategy field indicates evaluation strategies used to execute the query. For example, if query executor 154 transitions from a first evaluation strategy to a second evaluation strategy during query execution, then a first execution strategy field may indicate the first evaluation strategy and a second execution strategy field may indicate the second evaluation strategy.

Query executor 154 may manage the set of evaluation strategies within a single custom scan node of a query plan. The single custom scan node may facilitate the transitioning from the first evaluation strategy to the second evaluation strategy without specifying a reconstruction of the query plan associated with query 20. Query executor 154 may update an execution strategy field within the single custom scan node to reflect the second evaluation strategy in response to determining to execute the second portion of query 20 by at least applying the second evaluation strategy. For example, query executor 154 may generate a query plan that visually indicates the specific filtration strategy currently in use to user device 10. In an initial state, the query plan may display a custom scan node with an execution strategy label reading “Bitmap assisted vector Scan,” indicating an inline-filtering approach. Upon transitioning to a pre-filtering strategy during runtime, query executor 154 may dynamically update this label to read “Bitmap assisted pre-filtering” within the same custom scan node. This update preserves the overall node structure of the plan while providing transparent feedback regarding the adaptive switch performed by query executor 154.

Query executor 154 may interact with a columnar engine associated with the relational database. The columnar engine may generate an abstract bitmap representing, e.g., a set of data records that satisfy the one or more filter conditions. Query executor 154 may utilize an application programming interface provided by the columnar engine to iterate over the abstract bitmap during the execution of the first portion of the query.

Query executor 154 may utilize a cost model associated with the relational database to determine whether to transition from the first evaluation strategy to the second evaluation strategy. In some implementations, query executor 154 may determine to transition to the second evaluation strategy in response to a projected cost of the second evaluation strategy being lower than a projected cost of the first evaluation strategy. In still some implementations, query executor 154 may determine to transition to the second evaluation strategy in response to a projected cost of the second evaluation strategy being higher than a projected cost of the first evaluation strategy.

Statistics collector 164 may maintain a cumulative count of adaptive executions performed by query executor 154. Statistics collector 164 may label the cumulative count of adaptive executions with a type of adaptive switch associated with each of the adaptive executions. The type of adaptive switch may indicate a specific transition between the set of evaluation strategies including, e.g., a first evaluation strategy used and a second evaluation strategy used. Additionally, or alternatively, the type of adaptive switch may indicate a reason for initiating the transition.

Query executor 154 may identify a negative correlation by monitoring a first k amount of vectors during an execution of the inline-filtering evaluation strategy. Query executor 154 may track a number of qualifications or a number of disqualifications associated with the first k amount of vectors. In response to the number of disqualifications satisfying a disqualification threshold, query executor 154 may determine that the query vector and the one or more filter conditions are negatively correlated. Query executor 154 may transition to a pre-filtering evaluation strategy in response to the number of disqualifications satisfying the disqualification threshold.

Query executor 154 may transition from an ANN strategy (e.g., inline-filtering) to a second strategy (e.g., pre-filtering) in response to determining that the ANN strategy may fail to satisfy a recall requirement (e.g., during low selectivity scenarios). For instance, query executor 154 may identify that a low selectivity percentage associated with the ANN strategy may result in a low recall (e.g., a recall not satisfying a threshold). In response to transitioning to the second strategy, query executor 154 may provide a recall of 1 for the query because the second strategy may fetch all matching rows from the database (e.g., via an index or sequential scan) and sort the matching rows.

In some implementations, executing the second portion of the query includes discarding a result associated with the first portion of the query and executing the query using a second evaluation strategy, e.g., the second portion of the query may include or overlap the first portion of the query. For instance, query executor 154 may execute a first portion of query 20 using a first evaluation strategy. Query executor 154 may then determine to transition to a second evaluation strategy. Query executor 154 may discard all or some of the results associated with executing the first portion. Then, query executor 154 may execute the second portion of query 20 by restarting, from scratch, execution of query 20, where query executor 154 executes query 20 using the second evaluation strategy. Query executor 154 may execute the second portion of query 20 by fully executing query 20 using the second evaluation strategy.

In response to determining to execute the second portion of the query utilizing the second evaluation strategy, query executor 154 may discard a set of intermediate results that query executor 154 generated during an application of the first evaluation strategy. For instance, query executor 154 may discard a set of vectors that query executor 154 identified during a process of the inline-filtering evaluation strategy. Query executor 154 may subsequently execute the second evaluation strategy, such as the pre-filtering evaluation strategy, from a beginning state of the query execution.

System 100 of FIG. 1 is for illustrative purposes only and is not intended to be limiting. For example, although FIG. 1 shows only a single example of each component, system 100 may include any amount of components 10, 140, 150, and 152. Further, although FIG. 1 shows some components as located in cloud environment 140, in some implementations, user device 10 may host some or all of the components. In some examples, some or all of the components are hosted locally on user device 10, remotely (such as in cloud environment 140), or by some combination thereof.

As discussed, vector query processing in some relational database management systems supports different filter evaluation strategies, where each strategy may be best suited for a fixed range of selectivity. For instance, in PostgreSQL (and Relational Database Management Systems (RDBMS) in general), a query planner may plan queries using statistics generated based on a sampled row set. If the statistics are incorrect, the planner may choose to pick a suboptimal filter evaluation strategy, leading to poor performance and/or recall. For example, if the planner has not analyzed a table, the planner may not have accurate row distribution info for the table. If multiple filter conditions interact in non-obvious ways, the planner may misestimate a number of matching rows. The planner may select a suboptimal filter evaluation strategy if there is a correlation or decorrelation of filter conditions in the query plan. Furthermore, the planner may pick a suboptimal filter evaluation strategy if there is a correlation or decorrelation of the query vector with the filter conditions.

Furthermore, conventional query planners often utilize a cost model that prioritizes execution performance (e.g., execution speed and resource usage) without adequately accounting for recall accuracy, which is a critical factor in vector similarity searches. For instance, in scenarios involving low selectivity percentages, an Approximate Nearest Neighbor (ANN) search strategy may inherently fail to satisfy a high recall requirement. A planner relying solely on traditional performance-based cost statistics may inadvertently select such a suboptimal plan. The techniques of this disclosure enable query executor 154 to dynamically pivot to a strategy that prioritizes recall (such as a brute-force K-Nearest Neighbor search) when runtime statistics indicate that the initial strategy risks compromising result accuracy.

The techniques described with respect to this disclosure may enable a database management system to more efficiently execute queries. For example, by switching from a first evaluation strategy to a second evaluation strategy during query execution, the database management system may adapt based on queries submitted to the database management system. The database management system may therefore conserve energy, reduce hardware utilization, and/or reduce query execution time by dynamically implementing evaluation strategies well-suited to perform a provided query or set of queries.

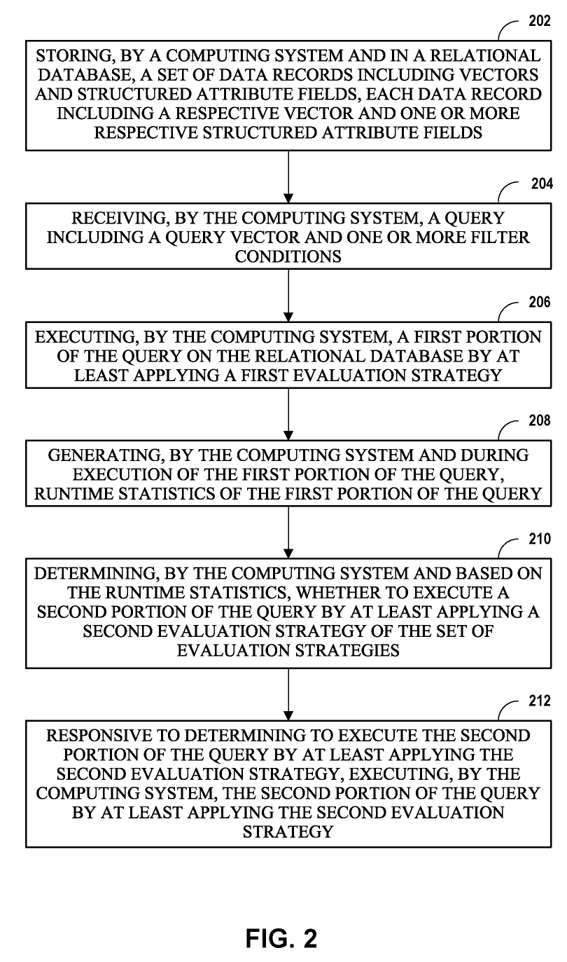

FIG. 2 is a flowchart illustrating an example technique for adapting a query evaluation strategy during query execution, in accordance with one or more techniques of this disclosure. The example of FIG. 2 is described with respect to FIG. 1.

In some implementations, the example technique may include storing, by a computing system and in a relational database, a set of data records including vectors and structured attribute fields, each data record including a respective vector and one or more respective structured attribute fields (202). For instance, cloud environment 140 may utilize data store 150 to store a set of data records. Data store 150 may organize the vectors and the structured attribute fields to support retrieval operations by query server 152.

The example technique may also include receiving, by the computing system, a query including a query vector and one or more filter conditions (204). Query server 152 may obtain query 20 from user device 10 via network 112. Query executor 154 may parse query 20 to identify the query vector and the one or more filter conditions before initiating a search of data store 150.

The example technique may further include executing, by the computing system, a first portion of the query on the relational database by at least applying a first evaluation strategy (206). The first evaluation strategy may be for searching the vectors based on the query vector and for searching the structured attribute fields based on the one or more filter conditions, and the first evaluation strategy may be from a set of evaluation strategies. Query executor 154 may select evaluation strategy module 156C from evaluation strategy modules 156 to initiate processing of query 20. Query executor 154 may generate a bitmap corresponding to the one or more filter conditions while applying evaluation strategy module 156C to the vectors and the structured attribute fields.

The example technique may additionally include generating, by the computing system and during execution of the first portion of the query, runtime statistics of the first portion of the query (208). Statistics collector 164 may gather query statistics 50 from shared memory 158 while query executor 154 processes the first portion of query 20. Query statistics 50 may indicate a selectivity rate of the one or more filter conditions or a size of a bitmap that query executor 154 generates.

The example technique may also include determining, by the computing system and based on the runtime statistics, whether to execute a second portion of the query by at least applying a second evaluation strategy of the set of evaluation strategies (210). The second evaluation strategy may be for searching the vectors based on the query vector and for searching the structured attribute fields based on the one or more filter conditions, and the second evaluation strategy may be different than the first evaluation strategy. Query executor 154 may compare query statistics 50 to an estimated amount of matching data records to determine whether to transition from the first evaluation strategy. Query executor 154 may select evaluation strategy module 156A or evaluation strategy module 156B as the second evaluation strategy in response to detecting a discrepancy between query statistics 50 and the estimated amount of matching data records.

The example technique may further include, responsive to determining to execute the second portion of the query by at least applying the second evaluation strategy, executing, by the computing system, the second portion of the query by at least applying the second evaluation strategy (212). For instance, query executor 154 may use evaluation strategy module 156A or evaluation strategy module 156B to process the second portion of query 20 against data store 150.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise random-access memory, read-only memory, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line, or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors, general purpose microprocessors, application specific integrated circuits, field programmable logic arrays, or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit or a set of integrated circuits (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in random-access memory or cache).

Example 1: A method includes storing, by a computing system and in a relational database, a set of data records including vectors and structured attribute fields, each data record including a respective vector and one or more respective structured attribute fields; receiving, by the computing system, a query including a query vector and one or more filter conditions; executing, by the computing system, a first portion of the query on the relational database by at least applying a first evaluation strategy, wherein: the first evaluation strategy is for searching the vectors based on the query vector and for searching the structured attribute fields based on the one or more filter conditions; and the first evaluation strategy is from a set of evaluation strategies; generating, by the computing system and during execution of the first portion of the query, runtime statistics of the first portion of the query; determining, by the computing system and based on the runtime statistics, whether to execute a second portion of the query by at least applying a second evaluation strategy of the set of evaluation strategies, wherein: the second evaluation strategy is for searching the vectors based on the query vector and for searching the structured attribute fields based on the one or more filter conditions; and the second evaluation strategy is different than the first evaluation strategy; and responsive to determining to execute the second portion of the query by at least applying the second evaluation strategy, executing, by the computing system, the second portion of the query by at least applying the second evaluation strategy.

Example 2: The method of example 1, wherein the set of evaluation strategies comprises a pre-filtering evaluation strategy, a post-filtering evaluation strategy, an inline-filtering evaluation strategy, and a hybrid inline-post filtering evaluation strategy.

Example 3: The method of example 2, wherein the first evaluation strategy is the inline-filtering evaluation strategy.

Example 4: The method of any of examples 1 through 3, further including: determining, by the computing system and prior to executing the first portion of the query, an estimated amount of matching data records for the first portion of the query; and determining, by the computing system and after executing the first portion of the query, an actual amount of matching data records for the first portion of the query, wherein determining whether to execute the second portion of the query by at least applying the second evaluation strategy comprises determining whether a difference between the estimated amount of matching data records and the actual amount of matching data records satisfies an evaluation strategy switching threshold.

Example 5: The method of example 4, further including determining, by the computing system, to execute the second portion of the query by at least applying the second evaluation strategy based on the difference indicating that the computing system overestimated the actual amount of matching data records, wherein the first evaluation strategy is an inline-filtering evaluation strategy and the second evaluation strategy is a pre-filtering evaluation strategy.

Example 6: The method of example 4, further including determining, by the computing system, to execute the second portion of the query by at least applying the second evaluation strategy based on the difference indicating that the computing system underestimated the actual amount of matching data records, wherein the first evaluation strategy is an inline-filtering evaluation strategy and the second evaluation strategy is a post-filtering evaluation strategy.

Example 7: The method of any of examples 1 through 6, wherein the computing system determines to execute the second portion of the query by at least applying the second evaluation strategy in response to determining that the query vector and the one or more filter conditions are negatively correlated.

Example 8: The method of example 7, wherein the first evaluation strategy is an inline-filtering evaluation strategy and the second evaluation strategy is a pre-filtering evaluation strategy.

Example 9: The method of any of examples 1 through 8, wherein executing the second portion of the query includes discarding a result associated with the first portion of the query and executing the query using the second evaluation strategy.

Example 10: A computing system includes one or more processors; and one or more storage devices that store instructions, that, when executed by the one or more processors, cause the one or more processors to: store, in a relational database, a set of data records including vectors and structured attribute fields, each data record including a respective vector and one or more respective structured attribute fields; receive a query including a query vector and one or more filter conditions; execute a first portion of the query on the relational database by at least applying a first evaluation strategy, wherein: the first evaluation strategy is for searching the vectors based on the query vector and for searching the structured attribute fields based on the one or more filter conditions; and the first evaluation strategy is from a set of evaluation strategies; generate, during execution of the first portion of the query, runtime statistics of the first portion of the query; determine, based on the runtime statistics, whether to execute a second portion of the query by at least applying a second evaluation strategy of the set of evaluation strategies, wherein: the second evaluation strategy is for searching the vectors based on the query vector and for searching the structured attribute fields based on the one or more filter conditions; and the second evaluation strategy is different than the first evaluation strategy; and responsive to determining to execute the second portion of the query by at least applying the second evaluation strategy, execute the second portion of the query by at least applying the second evaluation strategy.

Example 11: The computing system of example 10, wherein the set of evaluation strategies comprises a pre-filtering evaluation strategy, a post-filtering evaluation strategy, an inline-filtering evaluation strategy, and a hybrid inline-post filtering evaluation strategy.

Example 12: The computing system of example 11, wherein the first evaluation strategy is the inline-filtering evaluation strategy.

Example 13: The computing system of any of examples 10 through 12, wherein the instructions further cause the one or more processors to: determine, prior to executing the first portion of the query, an estimated amount of matching data records for the first portion of the query; and determine, after executing the first portion of the query, an actual amount of matching data records for the first portion of the query, wherein determining whether to execute the second portion of the query by at least applying the second evaluation strategy comprises determining whether a difference between the estimated amount of matching data records and the actual amount of matching data records satisfies an evaluation strategy switching threshold.

Example 14: The computing system of example 13, wherein the instructions further cause the one or more processors to determine to execute the second portion of the query by at least applying the second evaluation strategy based on the difference indicating that the computing system overestimated the actual amount of matching data records, wherein the first evaluation strategy is an inline-filtering evaluation strategy and the second evaluation strategy is a pre-filtering evaluation strategy.

Example 15: The computing system of example 13, wherein the instructions further cause the one or more processors to determine to execute the second portion of the query by at least applying the second evaluation strategy based on the difference indicating that the computing system underestimated the actual amount of matching data records, wherein the first evaluation strategy is an inline-filtering evaluation strategy and the second evaluation strategy is a post-filtering evaluation strategy.

Example 16: The computing system of any of examples 10 through 15, wherein the computing system determines to execute the second portion of the query by at least applying the second evaluation strategy in response to determining that the query vector and the one or more filter conditions are negatively correlated.

Example 17: The computing system of example 16, wherein the first evaluation strategy is an inline-filtering evaluation strategy and the second evaluation strategy is a pre-filtering evaluation strategy.

Example 18: The computing system of any of examples 10 through 17, wherein, to execute the second portion of the query, the one or more processors discard a result associated with the first portion of the query and execute the query using the second evaluation strategy.

Example 19: A non-transitory computer-readable storage medium encoded with instructions that, when executed by one or more processors of a computing system, cause the one or more processors to: store, in a relational database, a set of data records including vectors and structured attribute fields, each data record including a respective vector and one or more respective structured attribute fields; receive a query including a query vector and one or more filter conditions; execute a first portion of the query on the relational database by at least applying a first evaluation strategy, wherein: the first evaluation strategy is for searching the vectors based on the query vector and for searching the structured attribute fields based on the one or more filter conditions; and the first evaluation strategy is from a set of evaluation strategies; generate, during execution of the first portion of the query, runtime statistics of the first portion of the query; determine, based on the runtime statistics, whether to execute a second portion of the query by at least applying a second evaluation strategy of the set of evaluation strategies, wherein: the second evaluation strategy is for searching the vectors based on the query vector and for searching the structured attribute fields based on the one or more filter conditions; and the second evaluation strategy is different than the first evaluation strategy; and responsive to determining to execute the second portion of the query by at least applying the second evaluation strategy, execute the second portion of the query by at least applying the second evaluation strategy.

Example 20: The non-transitory computer-readable storage medium of example 19, wherein the set of evaluation strategies comprises a pre-filtering evaluation strategy, a post-filtering evaluation strategy, an inline-filtering evaluation strategy, and a hybrid inline-post filtering evaluation strategy.

Example 21: The non-transitory computer-readable storage medium of example 20, wherein the first evaluation strategy is the inline-filtering evaluation strategy.

Example 22: The non-transitory computer-readable storage medium of any of examples 19 through 21, wherein the instructions further cause the one or more processors to: determine, prior to executing the first portion of the query, an estimated amount of matching data records for the first portion of the query; and determine, after executing the first portion of the query, an actual amount of matching data records for the first portion of the query, wherein determining whether to execute the second portion of the query by at least applying the second evaluation strategy comprises determining whether a difference between the estimated amount of matching data records and the actual amount of matching data records satisfies an evaluation strategy switching threshold.

Example 23: The non-transitory computer-readable storage medium of example 22, wherein the instructions further cause the one or more processors to determine to execute the second portion of the query by at least applying the second evaluation strategy based on the difference indicating that the computing system overestimated the actual amount of matching data records, wherein the first evaluation strategy is an inline-filtering evaluation strategy and the second evaluation strategy is a pre-filtering evaluation strategy.

Example 24: The non-transitory computer-readable storage medium of example 22, wherein the instructions further cause the one or more processors to determine to execute the second portion of the query by at least applying the second evaluation strategy based on the difference indicating that the computing system underestimated the actual amount of matching data records, wherein the first evaluation strategy is an inline-filtering evaluation strategy and the second evaluation strategy is a post-filtering evaluation strategy.

Example 25: The non-transitory computer-readable storage medium of any of examples 19 through 24, wherein the computing system determines to execute the second portion of the query by at least applying the second evaluation strategy in response to determining that the query vector and the one or more filter conditions are negatively correlated.

Example 26: The non-transitory computer-readable storage medium of example 25, wherein the first evaluation strategy is an inline-filtering evaluation strategy and the second evaluation strategy is a pre-filtering evaluation strategy.

Example 27: The non-transitory computer-readable storage medium of any of examples 19 through 26, wherein, to execute the second portion of the query, the one or more processors discard a result associated with the first portion of the query and execute the query using the second evaluation strategy.

Example 28: A computing system comprising means for performing any combination of examples 1 through 9.

Example 29: A computer program product comprising one or more instructions that, when executed by a computing system, cause the computing system to perform any combination of examples 1 through 9.

What is claimed is:

1. A method comprising:
storing, by a computing system and in a relational database, a set of data records including vectors and structured attribute fields, each data record including a respective vector and one or more respective structured attribute fields;
receiving, by the computing system, a query including a query vector and one or more filter conditions;
executing, by the computing system, a first portion of the query on the relational database by at least applying a first evaluation strategy, wherein:
the first evaluation strategy is for searching the vectors based on the query vector and for searching the structured attribute fields based on the one or more filter conditions; and
the first evaluation strategy is from a set of evaluation strategies;
generating, by the computing system and during execution of the first portion of the query, runtime statistics of the first portion of the query;
determining, by the computing system and based on the runtime statistics, whether to execute a second portion of the query by at least applying a second evaluation strategy of the set of evaluation strategies, wherein:
the second evaluation strategy is for searching the vectors based on the query vector and for searching the structured attribute fields based on the one or more filter conditions; and
the second evaluation strategy is different than the first evaluation strategy; and
responsive to determining to execute the second portion of the query by at least applying the second evaluation strategy, executing, by the computing system, the second portion of the query by at least applying the second evaluation strategy.

2. The method of claim 1, wherein the set of evaluation strategies comprises a pre-filtering evaluation strategy, a post-filtering evaluation strategy, an inline-filtering evaluation strategy, and a hybrid inline-post filtering evaluation strategy.

3. The method of claim 2, wherein the first evaluation strategy is the inline-filtering evaluation strategy.

4. The method of claim 1, further comprising:
determining, by the computing system and prior to executing the first portion of the query, an estimated amount of matching data records for the first portion of the query; and
determining, by the computing system and after executing the first portion of the query, an actual amount of matching data records for the first portion of the query, wherein determining whether to execute the second portion of the query by at least applying the second evaluation strategy comprises determining whether a difference between the estimated amount of matching data records and the actual amount of matching data records satisfies an evaluation strategy switching threshold.

5. The method of claim 4, further comprising determining, by the computing system, to execute the second portion of the query by at least applying the second evaluation strategy based on the difference indicating that the computing system overestimated the actual amount of matching data records, wherein the first evaluation strategy is an inline-filtering evaluation strategy and the second evaluation strategy is a pre-filtering evaluation strategy.

6. The method of claim 4, further comprising determining, by the computing system, to execute the second portion of the query by at least applying the second evaluation strategy based on the difference indicating that the computing system underestimated the actual amount of matching data records, wherein the first evaluation strategy is an inline-filtering evaluation strategy and the second evaluation strategy is a post-filtering evaluation strategy.

7. The method of claim 1, wherein the computing system determines to execute the second portion of the query by at least applying the second evaluation strategy in response to determining that the query vector and the one or more filter conditions are negatively correlated.

8. The method of claim 7, wherein the first evaluation strategy is an inline-filtering evaluation strategy and the second evaluation strategy is a pre-filtering evaluation strategy.

9. The method of claim 1, wherein executing the second portion of the query comprises discarding a result associated with the first portion of the query and executing the query using the second evaluation strategy.

10. A computing system comprising:
one or more processors; and
one or more storage devices that store instructions, that, when executed by the one or more processors, cause the one or more processors to:
store, in a relational database, a set of data records including vectors and structured attribute fields, each data record including a respective vector and one or more respective structured attribute fields;
receive a query including a query vector and one or more filter conditions;
execute a first portion of the query on the relational database by at least applying a first evaluation strategy, wherein:
the first evaluation strategy is for searching the vectors based on the query vector and for searching the structured attribute fields based on the one or more filter conditions; and
the first evaluation strategy is from a set of evaluation strategies;
generate, during execution of the first portion of the query, runtime statistics of the first portion of the query;
determine, based on the runtime statistics, whether to execute a second portion of the query by at least applying a second evaluation strategy of the set of evaluation strategies, wherein:
the second evaluation strategy is for searching the vectors based on the query vector and for searching the structured attribute fields based on the one or more filter conditions; and
the second evaluation strategy is different than the first evaluation strategy; and
responsive to determining to execute the second portion of the query by at least applying the second evaluation strategy, execute the second portion of the query by at least applying the second evaluation strategy.

11. The computing system of claim 10, wherein the set of evaluation strategies comprises a pre-filtering evaluation strategy, a post-filtering evaluation strategy, an inline-filtering evaluation strategy, and a hybrid inline-post filtering evaluation strategy.

12. The computing system of claim 10, wherein the instructions further cause the one or more processors to:
determine, prior to executing the first portion of the query, an estimated amount of matching data records for the first portion of the query; and
determine, after executing the first portion of the query, an actual amount of matching data records for the first portion of the query, wherein determining whether to execute the second portion of the query by at least applying the second evaluation strategy comprises determining whether a difference between the estimated amount of matching data records and the actual amount of matching data records satisfies an evaluation strategy switching threshold.

13. The computing system of claim 12, wherein the instructions further cause the one or more processors to determine to execute the second portion of the query by at least applying the second evaluation strategy based on the difference indicating that the computing system overestimated the actual amount of matching data records, wherein the first evaluation strategy is an inline-filtering evaluation strategy and the second evaluation strategy is a pre-filtering evaluation strategy.

14. The computing system of claim 12, wherein the instructions further cause the one or more processors to determine to execute the second portion of the query by at least applying the second evaluation strategy based on the difference indicating that the computing system underestimated the actual amount of matching data records, wherein the first evaluation strategy is an inline-filtering evaluation strategy and the second evaluation strategy is a post-filtering evaluation strategy.

15. The computing system of claim 10, wherein, to execute the second portion of the query, the one or more processors discard a result associated with the first portion of the query and execute the query using the second evaluation strategy.

16. A non-transitory computer-readable storage medium encoded with instructions that, when executed by one or more processors of a computing system, cause the one or more processors to:
store, in a relational database, a set of data records including vectors and structured attribute fields, each data record including a respective vector and one or more respective structured attribute fields;
receive a query including a query vector and one or more filter conditions;
execute a first portion of the query on the relational database by at least applying a first evaluation strategy, wherein:
the first evaluation strategy is for searching the vectors based on the query vector and for searching the structured attribute fields based on the one or more filter conditions; and
the first evaluation strategy is from a set of evaluation strategies;
generate, during execution of the first portion of the query, runtime statistics of the first portion of the query;
determine, based on the runtime statistics, whether to execute a second portion of the query by at least applying a second evaluation strategy of the set of evaluation strategies, wherein:
the second evaluation strategy is for searching the vectors based on the query vector and for searching the structured attribute fields based on the one or more filter conditions; and
the second evaluation strategy is different than the first evaluation strategy; and
responsive to determining to execute the second portion of the query by at least applying the second evaluation strategy, execute the second portion of the query by at least applying the second evaluation strategy.

17. The non-transitory computer-readable storage medium of claim 16, wherein the set of evaluation strategies comprises a pre-filtering evaluation strategy, a post-filtering evaluation strategy, an inline-filtering evaluation strategy, and a hybrid inline-post filtering evaluation strategy.

18. The non-transitory computer-readable storage medium of claim 16, wherein the instructions further cause the one or more processors to:
determine, prior to executing the first portion of the query, an estimated amount of matching data records for the first portion of the query; and
determine, after executing the first portion of the query, an actual amount of matching data records for the first portion of the query, wherein determining whether to execute the second portion of the query by at least applying the second evaluation strategy comprises determining whether a difference between the estimated amount of matching data records and the actual amount of matching data records satisfies an evaluation strategy switching threshold.

19. The non-transitory computer-readable storage medium of claim 18, wherein the instructions further cause the one or more processors to determine to execute the second portion of the query by at least applying the second evaluation strategy based on the difference indicating that the computing system overestimated the actual amount of matching data records, wherein the first evaluation strategy is an inline-filtering evaluation strategy and the second evaluation strategy is a pre-filtering evaluation strategy.

20. The non-transitory computer-readable storage medium of claim 18, wherein the instructions further cause the one or more processors to determine to execute the second portion of the query by at least applying the second evaluation strategy based on the difference indicating that the computing system underestimated the actual amount of matching data records, wherein the first evaluation strategy is an inline-filtering evaluation strategy and the second evaluation strategy is a post-filtering evaluation strategy.
